(19) United States
(12) Patent Application Publication
(10) Pub. No.: US 2010/0273409 A1
(43) Pub. Date: Oct. 28, 2010

(54) APPARATUS FOR INDIVIDUALISING AND EXAMINING COINS

(76) Inventors: Klaus Meyer-Steffens, Deinste (DE); Anatolii Akulinin, Kiev (UA); Boris Golkov, Kiev (UA); Oleksandr Derkach, Kiev (UA)

Correspondence Address: DOCKET CLERK, P.O. DRAWER 800889, DALLAS, TX, 75380, US

(21) Appl. No.: 12/761,684

(22) Filed: Apr. 16, 2010

(30) Foreign Application Priority Data
Apr. 17, 2009 (EP) 09 005 508.8

(51) Int. Cl. G07D 3/14

(52) U.S. Cl. 453/4

(57) ABSTRACT

An apparatus for individualising and examining coins includes: a casing with a collecting box, which can accommodate a plurality of different coins in an unsorted condition, a rotor, disposed in the casing and rotatingly drivable in an inclined plane and having at least one coin accommodation, wherein the rotor passes through the collecting box with its at least one coin accommodation in a rotation, so that coins that are present in the collecting box are individually received by the at least one coin accommodation and are guided along a circular orbit, and a sensor device examining at least one characteristic property of the coins, on which coins received by the at least one coin accommodation are guided along by the rotation of the rotor. According to the present disclosure, it is provided that a selecting device is provided which can be triggered by a control unit depending on an examination result of the sensor device for a coin such that this coin is either supplied to a delivery opening or that this coin is guided along the sensor device by the rotor again.

### TECHNICAL FIELD

The present disclosure is related to an apparatus for individualising and examining coins, and particularly an apparatus including a rotor passing through a collecting box containing unsorted coins.

### BACKGROUND

One technique for individualising and examining coins employs a casing with a collecting box which can accommodate a plurality of different coins in an unsorted condition, a rotor disposed in the casing that is rotatably drivable in an inclined plane and having at least one coin accommodation. The rotor passes through the collecting box so that coins present in the collecting box are individually received by the at least one coin accommodation and guided along a circular orbit. A sensor device along a path in which coins received by the at least one coin accommodation are guided by the rotation of the rotor examines at least one characteristic property of coins.

Such apparatuses are increasingly installed at check-outs of supermarkets or the like, and are also used on tollbooths or in buses. A customer may pay in a convenient manner at the automatic payment machine equipped with such an apparatus, by simply dropping money (a handful of coins, for instance) as a bulk amount into a throw-in container. The apparatus starts automatically or is triggered externally after the bulk of coins has been thrown into the collecting box, and individualises the bulk of coins. Subsequently, the apparatus feeds the coins to a sensor device in order to identify the number and the value thereof. This saves time and simplifies the paying process.

DE 10 2005 056 191 B4 describes an apparatus for individualising coins is known which serves only for individualising the coins. An examination of the coins that might be necessary, as the case may be, must be arranged thereafter. The system disclosed features an integrated outlet flap connected by a mechanical arrangement in sync to a motor driving a rotating catch element.

DE 60 2006 000 526 T2 describes an apparatus representing a complete system for receiving and paying out coins. The coins are at first individualised in an individualising apparatus, and subsequently supplied from the individualising apparatus to an examination device, in which the coins are examined with respect to their genuineness and value.

GB 2 356 966 A describes an apparatus for individualising and examining coins, in which coins present in a collecting box are individually picked up by a rotating disc having a corresponding coin accommodation, and are guided past a sensor device for examining the coins in the course of rotation with the disc. A delivery opening is arranged after the sensor device in the rotational sense of the coins, and features a controllable ramp. Depending on the position of the ramp, the coins are guided out of the apparatus either through a first output shaft for accepted coins, or through a second output shaft for non-accepted coins.

U.S. Pat. No. 6,050,388 A describes a similar apparatus in which coins held in an accommodation of a rotating disc are at first guided along a sensor device, and then guided along a first and optionally a second delivery opening in the course of their further rotation. The first delivery opening has a slider element, by which the opening can be selectively closed or opened. In this manner, the coins can be supplied to a respective output shaft either through the first delivery opening or through the second, permanently opened delivery opening, depending on the result of the examination by the sensor, and thus be guided out of the apparatus.

A common feature of all the above-identified systems is that after individualisation, the coins can be guided out of the apparatus through either a first or a second delivery opening. Coins recognised as counterfeited or not recognised at all are then given back directly to the customer. If a rejected coin is genuine, the customer has to throw this coin back in one or plural times. In order to ensure a utilisation of the apparatus that is convenient for the customer in spite of this, the examination sensors have to be adjusted correspondingly fuzzy, in order to prevent that too great an amount of genuine coins are judged as being counterfeited. Through this, erroneous judgements become more frequent in which counterfeited coins are judged as genuine ones.

Starting from the state of the art described above, the present disclosure is based on the objective to provide an apparatus of the kind mentioned in the beginning, which permits to examine coins more accurately and to minimise erroneous judgements in a way that is simple, compact and convenient for the customer.

### SUMMARY

The present disclosure achieves this objective by the subject matter of claim 1. Advantageous embodiments are found in the dependent claims, the description and the FIGS.

For an apparatus mentioned in the beginning, the present disclosure resolves the objective in that a selecting device is provided which can be triggered by a control unit depending on an examination result of the sensor device for a coin, such that this coin is either supplied to a delivery opening or that this coin is guided along the sensor device by the rotor again. The rotor plane is inclined with respect to the vertical in the installed condition of the apparatus. The rotor may be disc-shaped e.g., for instance in the form of a payout disc, and in particular features a plurality of coin accommodations that may be arranged one behind the other in the rotational sense of the rotor. The rotor passes through the unsorted bulk of coins present in the collecting box and picks out coins by the coin accommodations. Coins held in the accommodations are then rotated past the sensor device by the rotor. The sensor device may comprise one or plural sensors and may also be arranged in the casing. The sensors may sense for instance physical properties of the coins, such as the material, the thickness, the diameter and so on. On this basis, the genuineness and the type (e.g., denomination) of the coins can be detected by the sensor device.

According to the present disclosure, coins that were not identified or recognised as being counterfeited can continue to rotate in the coin accommodation of the rotor after a first examination, so that they can be supplied to the sensor device again and correspondingly, one or more further examinations of the coins can take place. In particular, the coins can rotate and be examined in the apparatus for so long until given decision criteria concerning the genuineness and the type are fulfilled. The following decision criteria will be indicated by way of example:
The examined coin yields the same, erroneous measurement values repeatedly. The coin is then identified as counterfeited with a high probability and can be given back to the customer.
A coin that was not recognised or recognised as counterfeited in a first examination is recognised as genuine in subsequent examinations, in a second or third examination for instance, and correspondingly can be processed further normally.
A coin is not recognised or recognised as counterfeited after a first examination, and in subsequent examinations, in a second or third examination for instance, is indeed recognised as genuine but being in the fringe range of admissible measurement values that are given for the genuineness of the coins. Such a coin may subsequently be sorted out into a separate box as being not permitted for further circulation, or be treated according to other criteria.
A coin yields repeatedly undefined measurement signals, which do not permit the conclusion to be a metallic coin. In this case, the coin or disc, respectively, may be treated as waste or given back to the customer as being another object.

It is essential that with the apparatus of the present disclosure, a coin or an object to be examined, respectively, can rotate and be examined in the apparatus for so long as required until a meaningful decision on criteria about the coin have been found. In particular, the examinations proceed concealedly for the customer. According to the present disclosure, an accurate coin examination is possible through this, with erroneous judgements being minimal. The apparatus works more reliably and has a higher customer convenience. Furthermore, in the future money that is in fact genuine but no longer admissible for circulation due to wear or damage, for instance, has to be sorted out and should not be given back to the customer. Correspondingly, such coins must be collected separately and then drawn out of circulation. This is also possible with the apparatus of the present disclosure.

According to one embodiment, the delivery opening can branch into at least one first delivery line for accepted coins and at least one second delivery line for non-accepted coins, wherein a guiding element is provided, also adapted to be triggered by the control unit depending on an examination result of the sensor device for a coin, which connects the delivery opening either with the first delivery line or with the second delivery line. Thus, the delivery opening runs out in at least two delivery lines, delivery shafts for instance. The coins released from the coin accommodations are separated into acceptable and not acceptable coins by the guiding element as a switch. The guiding element may also be a flap. The second delivery line for not accepted coins may run out in a return box from which the coins are given back to the customer. The first delivery line may branch further into plural lines or boxes, respectively, where the accepted coins are sorted according to their recognised value or their permissiveness for circulation. The delivery lines may feature sensors (optical sensors or metal sensors for instance) monitoring whether the coins had been guided into the correct delivery line.

According to a further embodiment, the selecting device may feature a flap that can be opened and closed by the control unit depending on the examination result of the sensor device, wherein the flap closes the delivery opening in the closed condition, and opens the delivery opening in the opened condition, so that a coin guided over the delivery opening by the rotor can fall into the delivery opening by gravity. Thus, the flap and the delivery opening closed or opened by the same are disposed such that coins held in the coin accommodations are guided over the flap or the delivery opening, respectively, in the course of the rotor's rotation. In the closed condition of the flap, the coins can slip over the flap, whereas in the opened condition of the flap the coins fall into the delivery opening. The triggering of the flap that is provided according to the present disclosure can take place magnetically for instance, in particular by spring-loaded pull-type electromagnets. Further, the flap of the selecting device and/or the guiding element of the delivery opening may be kept open by e.g. a spring bias in the rest condition, that is to say for instance in the non-electrified condition, of a triggering electromagnet. Thus, in a failure of a triggering element it is made sure that the box will be emptied and coins contained therein will be given back to the customer. Closing the flap takes then place by actuating a triggering element against the bias.

According to a particularly practical embodiment, an inclined base plate on which the rotor rotates is disposed in the casing, the delivery opening being provided in the base plate and the flap which closes or opens the delivery opening being pivotally mounted on the base plate. Even a second flap may be provided which is identical with the first flap of the selecting device, except to its position. The two flaps may for instance be disposed in mirror symmetry to the vertical that runs through the rotor centre. In the operation, further devices, like for instance return money devices for returning coins as exchange money to a customer, follow to the apparatuses that are provided according to the present disclosure. Because the apparatuses have possibly to be disposed at different sides of for instance a check-out station, a corresponding space for the devices connected with them is frequently also only available at the one or at the other side of the apparatus. It may therefore be necessary to rotate the rotor clockwise or counter-clockwise, depending on the arrangement of the apparatus. The flap must therefore be disposed either at the one or at the other side of the apparatus. In the operation, the flap which is not necessitated can be kept closed permanently. Even other components of the apparatus, for instance the delivery opening and delivery lines, can be provided twice and each at one side of the apparatus at a time. In fact, all the devices except the drive motor of the rotor can be disposed in a mirror-like fashion. Thus, the apparatus is flexibly prepared for very different processes of operation. But for instance, it is also possible to arrange e.g. the delivery opening and the delivery lines centrally on the apparatus, so that one single delivery opening is suitable for any arbitrary utilisation of the apparatus.

According to a further embodiment, the at least one coin accommodation of the rotor can be at least one pocket-shaped recess. The pockets may for instance have a circular shape that is open at one side. They are formed so as to penetrate the rotor plane, such that the coins held therein can slide on a base plate that is provide below the rotor for instance. The rotor can have plural pocket-shaped recesses of different sizes, wherein at least one of the greater recesses has an additional opening in its region facing the rotor centre, which has a smaller size than the respective greater recess. In particular, the additional opening may have a smaller cross section than the diameter of a respective greater, essentially circular recess. The additional opening may for instance be slot-shaped. In this, the different pocket sizes are provided for coins of different sizes. They are selected depending on the currency provided for the utilisation of the apparatus, such that the greater coins just cannot be held in the small pockets. In fact, the smaller coins can be received in the greater pockets at first, but they will then drop out through a suitable opening of these pockets again. This opening is smaller than the diameter of the recess, so that greater coins held in the recesses cannot drop out.

Furthermore, the recess can taper in a V-shape in its region facing the rotor centre. By such a V-shaped realisation, the coins are safely held in the accommodation during their rotation, movements of the coins being minimised. This increases the measurement accuracy of the sensor device. It may then be provided further that an imaginary line, starting from the tip of the V-shape and running through the centre point of the basically circular shape, runs in an angle with respect to an also imaginary line which runs from the rotor centre in the radial direction of the rotor plane through the centre point of the basically circular shape. The angle may be for instance about 7.5°. Also, the sensor device can be disposed in the radial direction of the rotor starting from the rotor centre, wherein the radial line which connects the rotor centre with the sensor device runs in an angle with respect to the direction of the gravity acting on the coins, such that coins entrained by the rotor pass over the highest point of their circular orbit at first, and are subsequently guided along the sensor device. The angle may be for instance about 12.5°. That is to say, the pockets are aligned slantly with respect to the radial direction in this embodiment. Besides, for instance when the rotor rotates counter-clockwise, the sensor device is disposed in the region between the nine o'clock and the twelve o'clock position. To the contrary, when the rotor rotates clockwise, the sensor device is correspondingly provided between the twelve o'clock and the three o'clock position. Thus, the sensor device may be arranged for instance in the region of the eleven o'clock position or in the region of the one o'clock position, respectively. Thus, the centre point of the sensor module is somewhat rotated with respect to the vertical. This has the advantage that coins which are present in the pockets twice pass over the highest point of their circular orbit at first, and through this they have sufficient time to fall back into the collecting box due to the inclination of the rotor plane. So it is made sure that the coins pass the sensor device in the individualised condition. It is also conceivable to arrange the sensor device in the twelve o'clock position, but with the disadvantage that the coins that are present in the pockets twice have less time for falling back.

In order to ensure a stable position of the coins in the coin accommodations during the pass along the sensor device at the same time, even the pockets themselves are aligned inclinedly with respect to the vertical. Thus, small as well as big coins are stably positioned when present in the coin accommodations between entering in the measurement region of an optical sensor, a photoelectric barrier e.g., and leaving this measurement region, a second photoelectric barrier e.g. Otherwise, for instance a diameter measurement would be erroneous in an optical sensing procedure by way of a photoelectric barrier. This is of great importance just in the case that different coins in a great diameter range have to be processed with the apparatus.

According to a further embodiment, the rotor can have an enlargement in at least one region limiting the opening of a pocket-shaped recess. The enlargement may for instance be triangular in its cross section. Thus, the enlargement is provided on the edge of the opening of at least one coin pocket, of all of them in particular. It may be provided in particular on that edge which follows up the pocket opening in the rotational sense of the rotor. But it is also possible to provide such an enlargement in addition or alternatively on that edge which precedes the opening. The enlargement causes that a faster reception of the coin in the pocket occurs when only a few coins are still in the collecting box, especially at the last coin that is still contained in the collecting box. Thus, the enlargement causes a stirring effect when the collecting box is passed, which improves the coin reception, in particular when few coins are contained in the collecting box.

A further improvement of the position stability of the coins in the coin accommodations is achieved when the control unit is realised such as to rotatingly drive the rotor continuously. For instance, a sensor may be provided which detects if there are coins in the collecting box. Such a sensor may be an optical sensor or a metal sensor for instance. Upon a corresponding sensor signal, the control unit can then begin to rotate the rotor for the operation. The rotor is continuously rotated in this. Through this, fewer vibrations occur, and the coin movements that disturb the sensor measurements are minimised through this.

The closable delivery opening has also the advantage that the disc can be operated without start/stop operation, in order to ensure a continuous and thereby more accurate measurement of the coins. When the rotor disc rotates continuously, it might happen that the next following coin recognised as being genuine should not be sorted into the delivery opening yet, because a precursory coin that had been accepted before may still be in the processing region and might cause a clogging of the system. In this case, the delivery opening is closed by way of the movable flap, and the next coin is guided back into the box. Thus, the rotor disc has not to stop when a further coin is not to be sorted into the reception region. The delivery opening is released only when it is made sure that a next coin can be processed reliably.

According to a further embodiment, the collecting box can have a fall-down flap on its lower side, which can be opened and closed manually and/or through actuation by a motor, so that objects present in the collecting box fall into a fall-down opening by gravity. Undesired objects can be removed from the delivery opening through the fall-down flap. They can then be directed to a separate waste container, for instance, or given back to the customer. In case that opening and closing of the flap is done by a motor, the fall-down flap can be opened after each completed transaction e.g., in order to remove foreign matter that is still present in the container. Alternatively or in addition, manual operation of the flap, for instance by the customer, is also possible. The fall-down flap can have a device for recognising the end position, by which an end position of the fall-down flap that completely closes the fall-down opening can be detected. Objects may accumulate between the flap and a bearing surface of the casing, which prevent a complete closure of the flap. The detection of the end position is of decisive importance in order to make sure that coins thrown into the collecting box do not immediately fall into the fall-down opening. The end position detection may for instance comprise a device for monitoring the rotation of a motor which closes the flap, by which the number of the rotations of the motor is counted in particular. It is also possible to count the rotations of other components which rotate when the flap is closed, for instance those of an eccentric disc. On the basis of the counted rotations, it can be determined in each case whether the flap is completely closed or not. It can also be determined on the basis of the counted rotations whether the flap has reached the maximum opening. Alternatively, the end position of the fall-down flap can be detected by a photoelectric barrier in that the flap itself or a suitable lever which is fixedly connected in the position activates a sensor only in this end position. The sensor may be a photoelectric barrier, a reed contact, a Hall sensor or the like.

In order to safely prevent that small foreign objects or coins pass through, a groove can furthermore be provided on the casing, into which an edge of the fall-down flap closing the fall-down opening submerges in the closed condition of the fall-down flap. In order to prevent unintentional opening of the flap by objects present in the collecting box, the fall-down flap may be locked against unintentional opening in its closed position. The locking is then automatically released by opening the flap manually or by actuation through a motor.

The sensor device may feature arbitrary sensors for examining the coins. Optical sensors, metal sensors, electromagnetic sensor and the like may be considered for instance. Such sensors are per se known. For a particularly accurate measurement, a very accurate diameter measurement in particular, the sensor device can feature two optical sensors, which each one measure points in time of an entrance and the leaving of a coin into or out of, respectively, the measuring region of the optical sensors. The optical sensors may be lasers for instance, or have other suitable light sources that form photoelectric barriers which are opened and closed, respectively, by the coins when they run through the sensor device. By sensing the opening and the closing, respectively, of the photoelectric barriers, the diameter of the respective coin can be determined provided that the rotational speed of the rotor is known. In case that two optical sensors are provided, which sense in time the entering and the leaving, respectively, of a coin, four points in time are acquired. Thus, a bucking associated to the rotation of the rotor and being practically unavoidable can be compensated. Positive and negative accelerations of the coins occur through load changes even at continuous operation of the rotor with acceleration zero and constant motor speed, which can be compensated by sensing four points in time.

In order to reduce the expense for measurement, for instance one measuring point may be omitted, accompanied by corresponding reduction of the measurement accuracy. In order to further simplify the measurement, even only one optical sensor may be provided, so that only two measuring points are measured. In this case, the speed of the rotor is assumed to be constant, and bucking of the rotor is accepted. Losses of the measurement accuracy accompanied by this can be compensated through a somewhat broader adjustment of the acceptable diameter window. Furthermore, openings may be provided in the rotor, in the rotor blades for instance, in order to still safely sense the respective measuring points even at the biggest coins to be examined, which fill in a coin accommodation essentially entirely. These openings pass the photoelectric barrier or barriers, respectively, then always directly before and after the coin.

Apparatuses like those which are provided according to the present disclosure are fixed on supports in the operation. It can therefore be provided according to a further embodiment that the apparatus is locked or caught with its casing on a mounting plate. The mounting plate may have been screwed onto the support before in a simple manner. As locks, locking levers may be provided for instance, two locking levers in particular, which lock up when the apparatus is put on the mounting plate. Catch elements may be contemplated as catches, like snap-on hooks for instance, which catch when the end position of the apparatus on the mounting plate is reached. The advantage of this embodiment is that the apparatus may be mounted in a simple manner and also be dismounted in a simple manner for purposes of maintenance and service.

### BRIEF DESCRIPTION OF THE DRAWINGS

An example of the present disclosures realisation will be explained in more detail by way of the following FIGS., which show schematically:

FIG. 1 depicts an apparatus of the present disclosure in a perspective view from its front side;

FIG. 2 is the view from FIG. 1 without the rotor;

FIG. 3 is a first vertical sectional view of the apparatus of FIG. 1;

FIG. 4 is a second vertical sectional view of the apparatus of FIG. 1;

FIG. 5 is an enlarged detail of the depiction from FIG. 4;

FIG. 6 is an enlarged cut-out of a further vertical sectional view of the apparatus of FIG. 1 in a first condition of operation;

FIG. 7 is the cut-out of FIG. 6 in a second condition of operation;

FIG. 8 is a further vertical sectional view of the cut-out shown in FIG. 7;

FIG. 9 is a cut-out of a perspectivically cut view of the apparatus shown in FIG. 4;

FIG. 10 is the apparatus from FIG. 1 in a perspective view from its backside, the casing being opened;

FIG. 11 is a further vertical sectional view of the depiction from FIG. 4 in a cut-out;

FIG. 12 depicts two rotor discs that are provided according to the present disclosure;

FIG. 13 is a rotor disc that is provided in the present disclosure according to a further example of realisation; and

FIG. 14 is a diagram for illustrating the function of the sensor device of the present disclosure.

### DETAILED DESCRIPTION

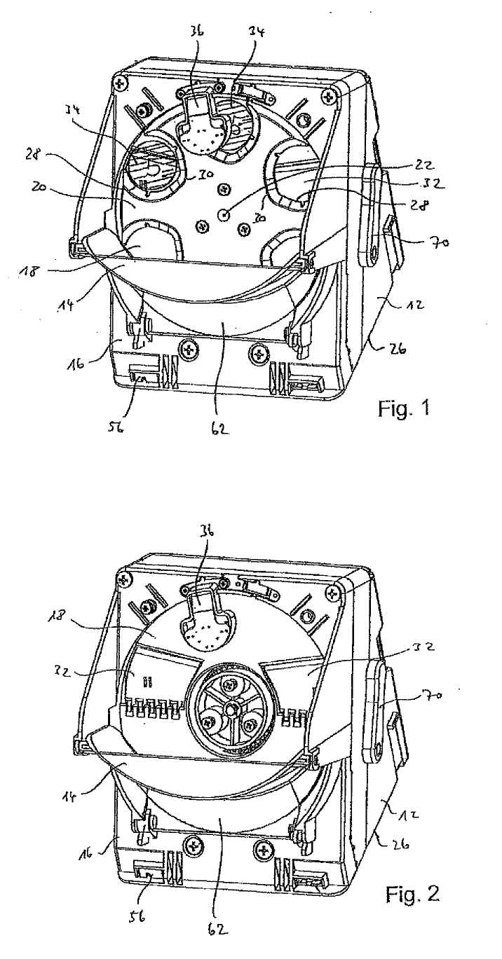

As far as not indicated otherwise, same reference signs designate same objects in the FIGS. In the FIGS., an apparatus for individualising and examining coins of the present disclosure is shown in different depictions. A casing 12 of the apparatus with a collecting box 14 provided on the lower end of the casing 12 into which a plurality of different coins are thrown in an unsorted condition, is shown in FIG. 1. The casing 12 is disposed inclinedly with respect to the vertical on its front side 16 which can be recognised in FIG. 1. Within the casing 12, there is a base plate 18, also inclined with respect to the vertical, which is partly covered up by a rotor 20 which is disposed in the casing 12 and rotatingly drivable in the inclined plane that is given by the base plate 18. Thus, the rotor 20 is rotatingly drivable around a rotational axis 22 which is inclined with respect to the horizontal. An electric motor 24, recognisable for instance in FIG. 10, is provided for the drive. For the sake of better illustration, the rotor 20 is not shown in FIG. 2. The apparatus shown in FIGS. 1, 2 and 10 e.g. is fastened on a support with its lower side 26, as will be explained in more detail below.

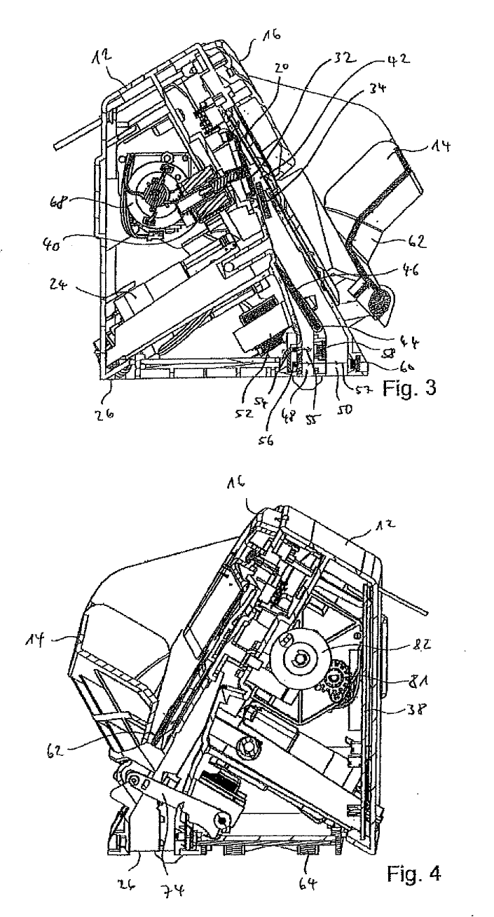

The rotor 20 has several coin accommodations 28, six in the shown example, in the form of pocket-shaped recesses 28. The pockets 28 have a circular base shape and are formed so as to run out into a V-shaped tip 30 at their end turned away from the rotor disc 20. As can be recognised in FIG. 2 in particular, two flaps 32 are pivotally articulated in the base plate 18. The flaps 32 are situated above one delivery opening for each of them, which branch into a first delivery line for accepted coins and a second delivery line for not accepted coins. This will be explained in more detail below, by way of FIG. 3. In the operation, only one of the flaps 32, and correspondingly also only one of the two delivery openings and delivery lines is used. In contrast, the respective other flap 32 remains permanently closed. In the example shown in the FIG.s, the rotor 20 is rotated counter-clockwise, so that the flap 32 at the right side in FIGS. 1 and 2 is permanently closed. In its rotation, the rotor 20 passes through the coins that are contained in the collecting box 14 in an unsorted condition and picks up the same individually into the coin accommodations 28. Two coins 34 are shown in the accommodations 28 in FIG. 1. In the course of their rotation, the coins 34 are guided along a sensor device 36. The sensor device 36 is disposed so as to follow after the apex point of the circular orbit described by the coins 34 in the rotational sense of the coins 34, so that the coins 34 pass over the apex point of the circular orbit at first, and subsequently over the sensor device 36. This will still be explained below in more detail by way of FIG. 12. One recognises that the sensor device has a size such that the sensor device 36 fits through the accommodation 28 of the rotor 20, so that the rotor disc 20 can be removed from the apparatus in a simple way for purposes of maintenance.

The flap 32 at the left side in FIGS. 1 and 2 can be selectively opened and closed by a control unit 38 (CPU-PCB) shown for instance in FIG. 4. For this purpose, a magnetic triggering element 40 to be recognised for instance in FIG. 3 is provided, which is triggered by the control unit 38. Through this, the flap 32 can be switched from the opened position shown in FIG. 3 for instance into the not shown closed position. A coin 34 guided over the flap falls into the delivery opening 42 that is released by the opened flap 32, as can be recognised in FIG. 3. In the further course of the shaft-like delivery opening 42, there is disposed a further flap 46, pivotally mounted via a pivot axis 44. The flap 46 is in particular situated in the region of a branching of the delivery opening 42 into a first delivery line 48 for accepted coins and a second delivery line 50 for not accepted coins. For triggering the flap 46, a further magnetic triggering element 52 is provided, which is also triggered by the control unit 38. By triggering the triggering element 52, the flap 46 can be swung around the pivot axis 44, and so the delivery opening 42 can be selectively connected with the first delivery line 48 or with the second delivery line 50. Two optical sensors 54, 56 are provided in the region of the delivery lines 48, 50, each of them co-operating with a prism 58, 60. In particular, the optical sensors 54, 56 each direct a light beam 55, 57 onto the prism 58, 60 associated to them. In the respective prism 58, 60, the light beam 55, 57 is deflected and guided to a corresponding optical sensor of the sensor devices 54, 56 again. Thus, sender and receiver of the sensors 54, 56 can sit on one electronic circuit board. When a coin 34 falls through the first or the second delivery line 48, 50, the corresponding light beam will be interrupted. Thus, it can be examined whether the coin 34 has indeed fallen into the correct exit 48, 50. The receiving shaft 48 is traversed by both light beams in this. In contrast, the return shaft 50 is traversed by only one of the light beams. Through this, direction recognition may also be performed for the receiving shaft.

The apparatus has furthermore a fall-down flap 62 on the lower side of the collecting box 14. The fall-down flap 62 is shown in the closed condition in the FIGS. 1 and 2. By opening the fall-down flap 62, objects can be removed from the collecting box 14, like this will be explained in more detail below. In particular, residual objects still remaining in the collecting box 14 fall downward by gravity and out of the apparatus in the opened condition of the fall-down flap 62 that is shown for instance in FIG. 3.

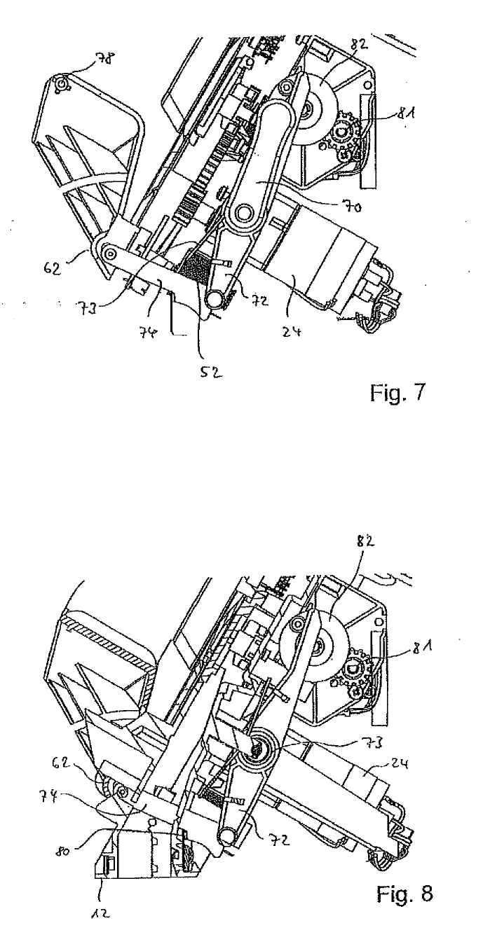

In the following, the fall-down flap 62 of the present disclosure will be explained in more detail by way of the FIGS. 3 to 8. The flap 62 is pivotally mounted on the collecting box 14 via a pivot axis 78. According to the present disclosure, the fall-down flap 62 may be actuated manually as well as by a motor. An electric motor 68 that can be recognised in FIG. 3, for instance, is provided for the actuation by motor. A hand lever 70 is provided for the manual actuation. By actuating the hand lever 70, a motor lever 72 connected to the same is actuated. Through this, a transfer lever 74 that is pivotally connected to the motor lever 72 is actuated, which is in turn pivotally connected with the fall-down flap 62. Through this, the fall-down flap 62 is moved into the opened position shown for instance in FIG. 6. It releases then an opening 76 at the lower side of the collecting box 14 for discharging objects. When the hand lever 70 is released, it will move back in its starting position by the restoring force of a spring 73 acting on the motor lever and being shown for instance in FIG. 10. The flap 62 is then moved into the closed position shown in FIG. 7 via the respective connections to the motor lever 72 and the transfer lever 74.

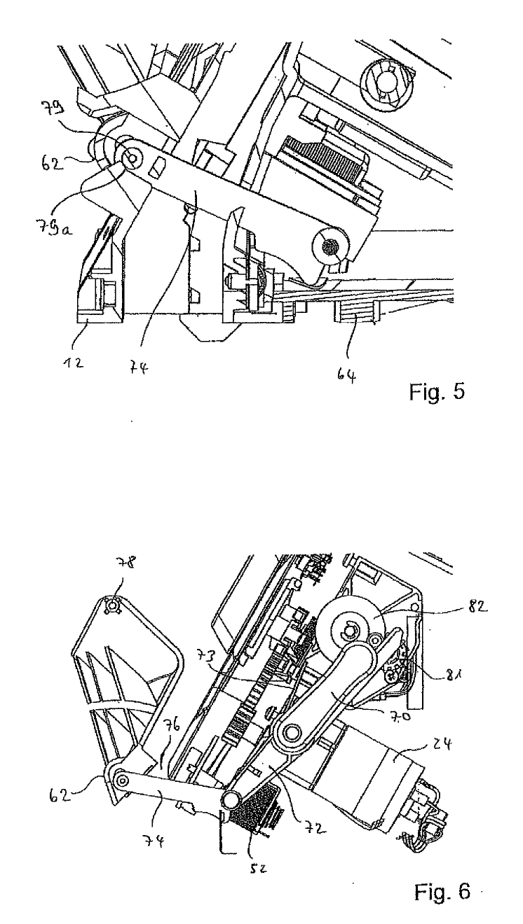

The completely closed position of the fall-down flap 62 is monitored by a device 80 for recognising the end position that is shown for instance in FIG. 8. In the shown example, the device for recognising the end position features an optical sensor device, which generates a light path which is interrupted at completely closed flap 62, so that the end position can be detected. However, other kinds of devices for recognising the end position are also conceivable, for instance micro-switches or inductive Hall sensors. In its closed position, the fall-down flap 62 is locked against unintentional opening through objects present in the collecting box. A lock 79 that can be recognised in FIG. 5 is provided for this purpose, co-operating with a bearing block 79a and being automatically unlocked when the fall-down flap 62 is opened manually or by motor action.

Alternatively or in addition, the fall-down flap 62 can be actuated by motor action of the electric motor 68. For instance triggered by the control unit 38, the fall-down flap 62 may then be automatically opened after each transaction, in order to remove foreign objects (waste) still present in the collecting box 14. For this purpose, the motor 68 is connected to an eccentric wheel 82 via a gearbox 81. By a motion of the eccentric wheel caused by the motor 68, for instance about 360°, the motor lever 72 is deflected like in a manual actuation, and the fall-down flap 62 is opened via the transmission lever 74.

In an actuation by motor, the completely closed end position of the flap 62 can be achieved alternatively or in addition by monitoring the eccentric wheel's position, for instance via a time loop in a micro-controller. In this, the time is taken for granted in which the motor 68 turns the eccentric wheel 82 once about 360°. This time depends on the applied supply voltage of the motor 68. From this, the complete opening of the flap 62 may be derived, which should be achieved after about 180°. When the end position cannot be found, for instance because foreign objects prevent the closure of the flap 62, the motor 24 for the rotor 20 can be put into operation in addition, in order to remove the foreign objects from the flap opening. When no end position of the flap 62 can be achieved even then, the system must be put out of operation, because it is not made sure that coins thrown in anew do not immediately fall out of the apparatus via the opened fall-down flap 62. It may also be provided that the motor 68 is equipped with a position recognition device itself. For this purpose, for instance each rotation of a gearbox wheel can be detected and counted. Such a procedure is very accurate and independent on the applied supply voltage and possible load conditions. The higher cost accompanied by such a motor is disadvantageous. Alternatively, a step-by-step motor can also be used.

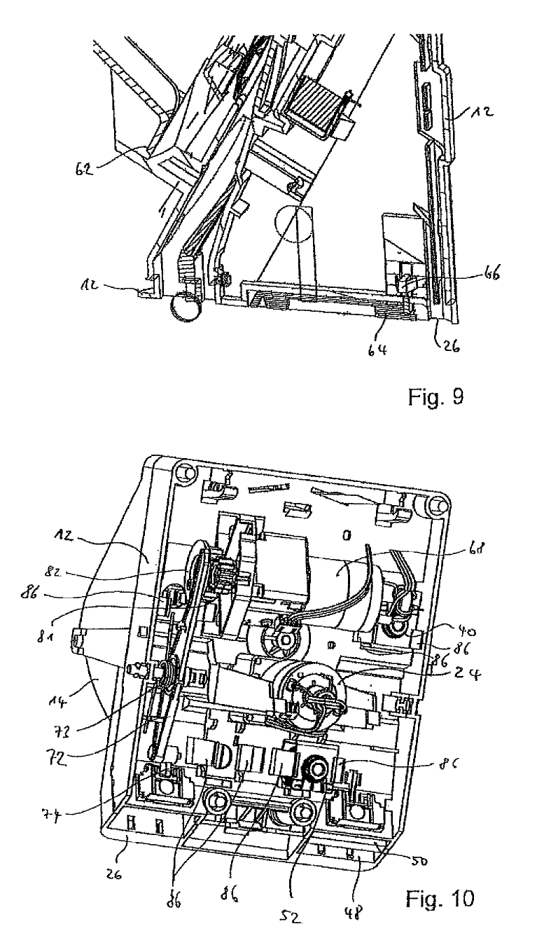

It can be recognised in the FIGS. 4 and 9 for instance that the apparatus is disposed on a mounting plate 64 with its lower side 26. This mounting plate may for instance be screwed on a support for the apparatus. The fastening of the casing 12 on the mounting plate 64 may take place by locking or catching in a particularly simple manner. A suitable locking element 66 is shown in FIG. 9.

As can be recognised in the FIGS. and in particular in the depiction in FIG. 10, the embodiment shown in the FIGS. where the rotor 20 rotates counter-clockwise can also be assembled to a solution where the rotor 20 rotates clockwise. All the components of the apparatus except the motor 24 for the rotor 20 can be mounted mirror-like for this purpose. One recognises also in FIG. 10 that the pull-type electromagnets 40 and 52 for actuating the flaps 32 and 46 can be snapped in a simple manner via catch hooks 86 and can be mirror-like mounted in a correspondingly simple way via corresponding catch hooks 86.

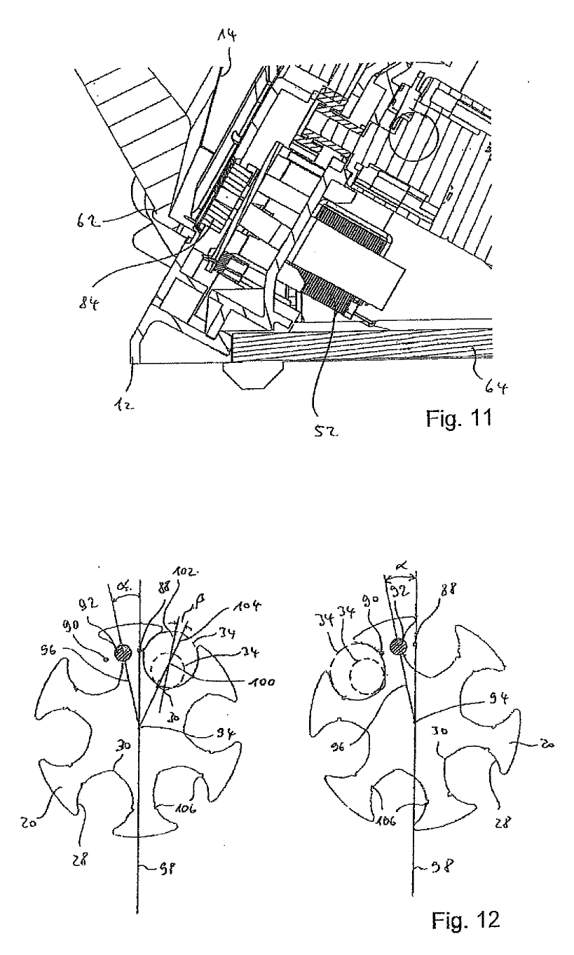

In the following, the function of the apparatus of the present disclosure will be explained. In the operation of the apparatus, several coins are given into the reception of the collecting box 14 by a customer at first, in an unsorted condition. A switch-on sensor 84 can be schematically recognised in the cut-out depiction in FIG. 11. The switch-on sensor 84 may e.g. be an optical sensor or a metal sensor. It recognises if objects, like coins for instance, are filled into the collecting box 14. The switch-on sensor 84 is connected to the control unit 38 and notifies the presence of coins to the same. Subsequently, the control unit 38 puts the motor 24 for the pay-out disc 20 into counter-clockwise movement. Now, the rotor 20 fishes individual coins from the collecting box 14 by its pockets 28, and conveys them along the sensor device 36. When passing the sensor device 36, the physical properties of the coins, like material, thickness, diameter etc. are sensed by the same. On this basis, the genuineness as well as the type of the coin 34 is determined by the control unit 38. This recognition by sensor is per se known for those skilled in the art and will therefore not be explained in more detail. The sensor device 36 can also be combined with other measurement devices in a per se known manner, in case that particular properties of the coin 34 are to be examined.

In case that a coin is recognised as unambiguously genuine or as unambiguously counterfeited by the sensor device 36, the control unit 38 does not actuate the triggering element 40 and thus also not the flap 32. Thus, the triggering element 40 and the flap 32 remain in their rest positions. In this rest position, the flap 32 is in the opened position shown in FIG. 3, in which it releases the delivery opening 42. In the course of its further rotation, the coin 34 falls therefore into the delivery opening 42 by gravity, as this is shown in FIG. 3. In contrast, if the coin 34 would not have been recognised as unambiguously genuine by the sensor device, or a repeated examination would have been desirable when recognised as counterfeited, the control unit 38 would have triggered the triggering element 40 and thus it would have closed the flap 32. In this case, the coin 34 would have slipped over the flap 32 and would have been supplied to the sensor device 36 by the rotor 20 for a second examination. This can be repeated for so long until there is a sufficient measurement basis for a decision about the genuineness of the coin. Furthermore, the controllable delivery flap 32 permits the continuous rotation of the payout-disc motor 24, and with this of the rotor 20. The sensor measurement becomes more accurate through the continuous rotation of the motor 24. Besides, the flap 32 can remain closed for instance also in case that a subsequent coin recognised as genuine is still not permitted to be given into the delivery opening 42, because a previous coin is still present in the delivery opening 42.

The coin 34, recognised as unambiguously genuine or unambiguously counterfeited and fallen into the delivery opening 42, falls now further downward by gravity along the shaft-like delivery opening 42. In case that this coin 34 had been recognised as counterfeited, the triggering element 52 is not actuated by the control unit 38, so that the flap 46 remains in its rest position, i.e. in the position shown in FIG. 3, in which the coin 34 falls into the delivery line 50 for not accepted coins. It may then be given back to the customer. In contrast, if the coin 34 has been recognised as being genuine, the control unit 38 activates the triggering element 52 and through this the flap 46, and the coin 34 falls into the delivery shaft 48 for accepted coins. This coin may then be guided to the cash desk or to further processing. This procedure is repeated for so long until all the coins are removed from the collecting box and have been processed.

After the completion of a transaction, thus in particular when all the coins thrown into the collecting box 14 have been sorted out of the apparatus, not transportable remaining objects or discs which have not been sorted out can be removed by opening the fall-down flap 62. For this purpose, the fall-down flap 62 can be opened in the manner explained above, for instance by the motor 68, as this is shown in FIG. 3. The remaining parts present in the collecting box 14 fall now downward by their gravity and out of the apparatus. In addition, the rotor 20 can be put into operation by the motor 24, in order to remove object possibly still remaining in the pockets 28 of the rotor 20 or in order to detach objects that are clamped in the apparatus. The fall-down flap 62 is thereafter closed again, controlled by time and through sensors. The end position of the fall-down flap 62 is determined via the end position sensor 80 in order to signalise the correct operation of the apparatus for the transaction. Alternatively, the fall-down flap 62 may also be actuated via the manual hand lever 70.

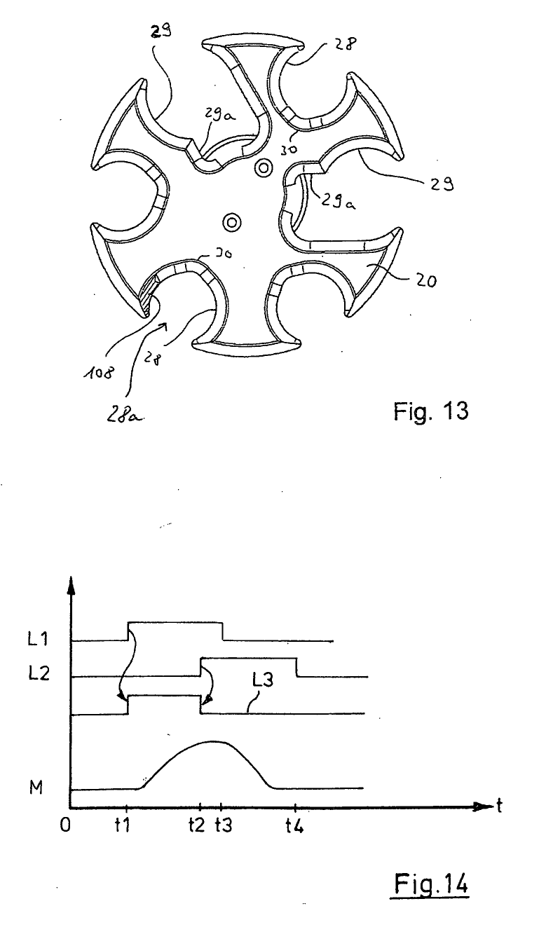

The function of the sensor module 36 of the present disclosure will be explained in more detail below, by way of the FIGS. 12, 13 and 14. In the example shown in FIG. 12, the rotor 20 has six pocket-shaped recesses 28 distributed uniformly over its perimeter. It is also possible to provide a rotor 20 with pockets 28, 29 of different sizes, as this is shown in FIG. 13 by way of example. In the shown example, the rotor 20 has four smaller pockets 28 and two bigger pockets 29. Of course, the number and size distribution of the pockets 28, 29 can also be selected otherwise in a respective suitable manner. The pocket sizes are matched such that bigger coins cannot be received in the smaller pockets 28. In contrast, the bigger pockets 29 are formed such that two of the smaller coins of the currency to be examined cannot be held in one of the bigger pockets 29. Moreover, the bigger pockets 29 have a for instance slot-shaped opening 29a on the side turned away from the rotor's outer perimeter. The openings 29a are adapted in their size to the diameter of the smaller pockets 28 such that coins received in the bigger pockets 29 of the currency to be examined, which fit also into the smaller pockets 28 with their perimeter, fall out from the bigger pockets 29 through the openings 29a. In contrast, bigger coins do not fit into the openings 29a and are safely held in the bigger pockets 29. Thus, it is ensured that only those coins sizes are accommodated in the pockets 28, 29 which are provided for these pockets 28, 29. The rotor 20 has an enlargement in its respective regions which limit the openings 28a of the recesses 28, 29. An enlargement for one of the recesses 28 is shown in shaded lines at the reference sign 108 in FIG. 13 by way of example. The enlargement 108 is provided on the edge of the opening 28a of the coin pockets 28, 29. In the example shown in FIG. 13, the rotor 20 rotates counter-clockwise, so that the enlargement is provided on that edge which follows up the pocket opening 28a in the rotational sense of the rotor 20. Of course, an enlargement can also be provided on those edges of the rotor 20 that precede the openings 28a. A stirring effect is generated through the enlargement 108 when the collecting box 14 is passed, which improves the coin reception in the coin pockets 28, 29, in particular when few coins 34 are contained in the collecting box 14. Even though this is not shown, corresponding enlargements 108 can of course be also provided in the rotor 20 shown in FIG. 12.

The arrangement of the sensor device will be explained in more detail by way of FIG. 12. Of course, the sensor arrangement described below could also be provided in the rotor 20 shown in FIG. 13. Two optical sensors 88, 90 and a material sensor 92, working for instance via induction and forming the centre point of the sensor device 36, are shown in FIG. 12 by way of example. At first, one recognises that the centre point of the sensor device 36 formed by the sensor 92 is disposed along a radial line 96, which starts from the rotor centre 94. The radial line 96 runs in an angle β to the vertical 98, which constitutes the direction of the gravity acting on the coins 34 at the same time. In particular, the centre point of the sensor device 36 is rotated to the left for about 12.5° in the shown example, so that when the rotor 20 is rotated counter-clockwise, the coins 34 present in the pockets 28 pass the apex point of their circular orbit at first, and subsequently the sensor device. Moreover, one recognises in FIG. 12 that an imaginary line 102, running from the tip 30 of the V-shape of the recesses 28 and through the centre point 100 of the circular base form of the pockets 28, runs in an angle β with respect to an imaginary line 104 that runs from the rotor centre 94 in the radial direction through the centre 100 of the circular recess 28. In the shown example, the angle β is about 7.5°. The optical sensors 88, 90 each generate a photoelectric barrier which runs vertically to the plane of projection in FIG. 12. In the course of their movement, the coins 34 pass both photoelectric barriers of the sensors 88 and 90, and also the centrally disposed material sensor 92. During this pass, the coins 34 should not move in the openings 28, as far as this is possible. Each recess 28 has corresponding openings 106 on its perimeter, in order to permit the measurement by the photoelectric barriers even for the big coins 34, depicted in dashed lines in FIG. 12, which completely fill in the recesses 28. Although this is not depicted in FIG. 13, the rotor disc shown in FIG. 13 can of course also be provided with corresponding openings 106. This is advantageous at different pocket sizes in particular, because the blade width of the rotor 20 can be determined by this, so that the information for the sensor measurement is at hand whether one of the bigger ones or one of the smaller pockets 28, 29 passes the sensor device 36 next. In this manner, measurement errors are avoided, when for instance small coins in the smaller pockets 28 and coins lying deeply in the bigger pockets 29 would otherwise yield the same values for the diameter.

The beginning of a diameter measurement of a coin 34 is shown in the left partial image in FIG. 12. The end of a diameter measurement is shown in the right partial image of FIG. 12. The optical sensors 88, 90 measure the respective points in time where the photoelectric barrier is interrupted and opened again. In FIG. 14, this measurement is plotted against the time t for the photoelectric barriers L1 and L2 of the optical sensors 88 and 90, respectively. One recognises the time offset between the respective measuring points t1 and t3 of the first measurement device 88, and t2 and t4 of the second measurement device 90. The curve L3 with the measuring points t1 and t2 can be determined from the curves L1 and L2. Thus, the diameter of the coins 34 can be determined in a per se known manner. The measurement signal of the material sensor is depicted by the curve M in FIG. 14. The material of the coin 34, and by this the type and the genuineness thereof, can be inferred through this. The highest accuracy is achieved when all the four measuring points t1, t2, t3 and t4 are included. Then, even bucking of the rotor disc in the course of the rotation will be compensated too. Alternatively, for instance the measuring point t4 may be omitted. The measurement accuracy is only slightly reduced through this. Furthermore, it may be provided that only one optical sensor is provided for the measurement, which yields the measuring points t1 and t2. However, the speed of the rotor 20 must be presumed as constant in this case. Even though this is accompanied by reduced measurement accuracy, cost is reduced by doing so.

It is suggested that even though only one control unit 38 is provided in the FIGS. for analysing the sensor results and for triggering the components of the apparatus, in particular the rotor 20 and the flaps 32 and 46, two control units in the form of micro-processors might be provided too, wherein one unit controls the coin examination, and a second one the control process and an external interface of the apparatus.

What is claimed is:

1. An apparatus for individualising and examining coins, comprising:
a casing with a collecting box, which can accommodate a plurality of different coins in an unsorted condition,
a rotor, disposed in the casing and rotatingly drivable in an inclined plane and having at least one coin accommodation, wherein the rotor passes through the collecting box with its at least one coin accommodation in a rotation, so that coins that are present in the collecting box are individually received by the at least one coin accommodation and are guided along a circular orbit, and
a sensor device examining at least one characteristic property of the coins, on which coins received by the at least one coin accommodation are guided along by the rotation of the rotor,
characterised in that a selecting device is provided which can be triggered by a control unit depending on an examination result of the sensor device for a coin such that this coin is either supplied to a delivery opening or that this coin is guided along the sensor device by the rotor again.

2. An apparatus according to claim 1, characterised in that the delivery opening branches into at least one first delivery line for accepted coins and at least one second delivery line for non-accepted coins, wherein a guiding element is provided, also adapted to be triggered by the control unit depending on an examination result of the sensor device for a coin, which connects the delivery opening either with the first delivery line or with the second delivery line.

3. An apparatus according to claim 1, characterised in that the selecting device features a flap which can be opened and closed by the control unit depending on the examination result of the sensor device, wherein the flap closes the delivery opening in the closed condition, and opens the delivery opening in the opened condition, so that a coin that is guided over the delivery opening by the rotor can fall into the delivery opening by gravitation.

4. An apparatus according to claim 3, characterised in that an inclined base plate on which the rotor rotates is disposed in the casing, wherein the delivery opening is provided in the base plate and the flap which closes or opens the delivery opening is pivotally mounted on the base plate.

5. An apparatus according to claim 1, characterised in that the at least one coin accommodation of the rotor is at least one pocket-shaped recess.

6. An apparatus according to claim 5, characterised in that the rotor has plural pocket-shaped recesses of different sizes, wherein at least one of the greater recesses has an additional opening in its region facing the rotor centre, which has a smaller size than the respective greater recess.

7. An apparatus according to claim 5, characterised in that the at least one pocket-shaped recess has a basically circular shape, wherein the recess tapers in a V-shape in its region facing the rotor centre.

8. An apparatus according to claim 7, characterised in that an imaginary line, starting from the tip of the V-shape and running through the centre point of the basically circular shape, runs in an angle (B) with respect to an also imaginary line which runs from the rotor centre in the radial direction of the rotor plane through the centre point of the basically circular shape.

9. An apparatus according to claim 5, characterised in that the rotor has an enlargement in at least one region limiting the opening of a pocket-shaped recess.

10. An apparatus according to claim 1, characterised in that the sensor device is disposed in the radial direction of the rotor starting from the rotor centre, wherein the radial line which connects the rotor centre (94) with the sensor device runs in an angle (β) with respect to the direction of the gravity acting on the coins, such that coins entrained by the rotor pass over the highest point of their circular orbit at first, and are subsequently guided along the sensor device.

11. An apparatus according to claim 1, characterised in that the control unit is realised such as to rotatingly drive the rotor continuously.

12. An apparatus according to claim 1, characterised in that the collecting box has a fall-down flap on its lower side, which can be opened and closed manually and/or through actuation by a motor, so that objects present in the collecting box fall into a fall-down opening by gravity.

13. An apparatus according to claim 12, characterised in that the fall-down flap has a device for recognising the end position, by which the end position of the fall-down flap that completely closes the fall-down opening can be detected.

14. An apparatus according to claim 12, characterised in that a groove is provided on the casing (12), into which an edge of the fall-down flap closing the fall-down opening submerges in the closed condition of the fall-down flap.

15. An apparatus according to claim 12, characterised in that in its closed condition, the fall-down flap is locked against unintentional opening caused by objects that are present in the collecting box.

16. An apparatus according to claim 1, characterised in that the sensor device features two optical sensors, which each one measure points in time of an entrance and a leaving of a coin into or out of, respectively, the measuring region of the optical sensors.
